(19) United States
(12) Patent Application Publication
(10) Pub. No.: US 2009/0063560 A1
(43) Pub. Date: Mar. 5, 2009

(54) METHOD AND SYSTEM FOR PATENT CLAIM MANAGEMENT AND ORGANIZATION

(76) Inventors: Linda Wallace, Carleton Place (CA); Vyacheslav Zavadsky, Ottawa (CA); Edward Keyes, Ottawa (CA); Jason White, Ottawa (CA)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/847,706

(22) Filed: Aug. 30, 2007

(51) Int. Cl. G06F 17/30

(52) U.S. Cl. 707/104.1; 707/E17.005

(57) ABSTRACT

A method and system for organizing and managing claim elements and reference objects is disclosed. The method and system establish database links between claim elements and reference objects based on associations identified between them. These database links are then stored in the database for future reference. The links are also used to derive additional associations between other claim elements and reference objects. The method and the system also enable the displaying of claim elements and reference objects to users in a way that illustrates the associations between the claim elements and reference objects. Associations may be defined based on similarities or dissimilarities between claim elements and reference objects, and amongst claim elements and reference objects, respectively.

### FIELD OF THE INVENTION

The present invention relates to patent claim management tools and more particularly to patent claim management tools for performing prior art and infringement analysis.

### BACKGROUND OF THE INVENTION

Intellectual property is a burgeoning field. In the modern information age, intellectual property, and in particular patents for invention, is the new currency. Both the number of patent applications filed and the number of patents being litigated continue to increase.

As the stakes increase for both patent holders and those accused of patent infringement, the effort on the one hand to establish infringement and on the other hand to invalidate patents has increased.

From the point of view of the patent holder, it is not uncommon to assert a number of related patents in a patent family. Some of the patents in a patent family derive from the patent holder's desire to protect different inventive aspects of an innovative product.

Other patents are artifacts of the prosecution process, in which the patent applicant may decide to file or seek to reissue the patent, or the patent examiner may requisition, additional filings such as continuation, continuation-in-part (CIP) and/or divisional applications.

Still other of the patents in a patent family derive from the multi-national nature of modern commercial activity and the national boundaries of patent regimes. A company's significant inventions may be protected by patents in a number of patent jurisdictions. In many instances, the patent application and the claims, while similar, may not be identical, having regard to technological developments during the (Paris Convention) priority year. The form of patent claims may have to be varied to account for local practice requirements and conventions, such as differences in the form of claims, restrictions on patentable subject matter in the local jurisdiction, and differing rules about what constitutes applicable prior art.

Beyond the potentially wide number of patents that may be considered in patent litigation, a given patent may consist of a large number of claims, directed at different forms of the invention (method, system, product, process, apparatus, compound, composition, use, method of manufacture, computer-readable medium, software, etc.) and also different aspects or combinations of the essential features of the invention. Each of these claims may share some or all of the constituent claim elements, in various permutations and combinations.

Further, it is not uncommon to have varying sets of dependent claims to cover different desired combinations and permutations. Indeed, it is conceivable that a single dependent claim may be multiple-dependent, so that the constituent elements thereof may be different, based on the nature of the parent claim from which it is considered to depend.

Thus, in patent litigation, the cause of action may encompass a large number of patents, each of which may contain a large number of independent claims and associated dependent claims.

Additionally, each of the asserted patents may be asserted against a plurality of accused infringing devices, which may vary by product line and/or model.

On the other hand, defendants will attempt to establish the invalidity of the asserted patents and claims. Typically, the most effective method of so doing is to identify one or more prior art references that may disclose all the elements of one or more claims of the asserted patents.

Accordingly, litigants will frequently conduct extensive patent searches in databases around the world to identify potentially relevant prior art. Such searches are not restricted to patent databases. Citable prior art may be uncovered in printed publications, marketing materials, plans, working models and prototypes, samples and the like.

As a result, it is not uncommon to find many hundreds of potential prior art references that are to be considered for application against each of the many patent claims that may be in issue in the patent litigation.

The concept of patent claim analysis lies at the heart of this litigation exercise. In patent claim analysis, claims are broken up into constituent claim elements, parsed and analyzed to see whether all or a significant number of the constituent elements are found in an accused infringing device or in one or more prior art references.

It should be mentioned that, while this document will refer throughout to infringing devices, the discussion of the prior art and the present invention is not limited to infringing devices only. The term “infringing devices” should be broadly interpreted to mean any infringing methods, systems, products, processes, apparatus, compounds, compositions, uses, methods of manufacture, computer-readable media, software, etc.

The sheer number of the claim sets in a patent, the number of patents in a related patent family, the number of potential accused infringing devices and the number of potential prior art references that may be involved in a modern patent litigation matter has rendered practically obsolete traditional methods of conducting such analysis.

Such methods include creating claim charts, in which each sub-paragraph (or portion thereof) of each claim, hereinafter referred to as a claim element, being considered is listed in a column of a printed chart, and the remaining columns are devoted to, in the case of infringement analysis, each of the accused infringing devices, and in the case of validity analysis, each of the citable prior art references.

However, with the immense scope of the patent claim analysis task, the claim chart could easily span several pages. As a result, the primary advantage of such claim charts, which is to provide a graphical and thus easily discernable summary of the similarities, if any, between the claim(s) being asserted and the accused device(s) or prior art reference(s), is largely obviated.

The primary objective behind the preparation of the claim chart is to identify whether the features of a claim element may be found in an accused infringing device or a prior art reference. Thus, the chart could conceivably be completed, simply by adding a cursory positive or negative annotation in the appropriate chart cell.

However, in many cases, the question is not easily answered. The answer may depend upon the proper interpretation or construction of the claim element, or the claim element may encompass a number of features, one or more of which is present and one or more of which is absent. In such a situation, a simple binary annotation may not be adequate for analysis purposes. Not infrequently, reference to the patent specification and to the accused device and/or prior art reference is advisable.

More evolved approaches to patent claim analysis therefore make provision for a further column to identify where the claim element under scrutiny is introduced, defined and/or construed in the patent being asserted, and for the entries corresponding to an accused device and/or prior art reference to contain not just a binary annotation, but a page/line and/or figure reference back to the accused device/prior art reference, so that such consultation can be facilitated. However, in so doing, the complexity of the claim chart is further increased.

Furthermore, the patent claim analysis process, whether or not embodied in a claim chart, has been hitherto largely a manual exercise.

In a purely manual analysis process, each of these instances of the same claim element will demand separate and thus duplicated analysis, which in the overall scheme is generally wasted effort. Unfortunately, in a manual process, it is often difficult to recognize this duplication in sufficient time to avoid it.

A more significant problem arises where inconsistent and in the worst case conflicting analyses are inadvertently obtained for identical claim elements, which would weaken the force of the analysis and may create a seemingly insurmountable but likely entirely avoidable hurdle to establishing infringement or invalidity as the case may be.

It would therefore be advantageous to have a method and apparatus for facilitating the patent claim analysis process.

### SUMMARY OF THE INVENTION

A method and system for organizing and managing claim elements and reference objects is disclosed. The method and the system establish database links between claim elements and reference objects based on associations identified between them. These database links are then stored in the database for future reference. The links are used to derive additional associations between other claim elements and reference objects. The method and the system also enable the display of claim elements and the reference objects to users in a way that illustrates the associations between the claim elements and reference objects.

Associations may be defined based on similarities or dissimilarities between claim elements and reference objects, and amongst claim elements and reference objects, respectively.

A significant advantage of the present invention is that it provides a patent claim management tool which permits an already-completed analysis on a given claim element to be propagated to other instances of the claim element, whether in a different claim, a different patent or even a different patent family.

Another advantage of the method and apparatus of the present invention is that it permits easy and convenient reference to resources describing the various accused infringing devices and/or prior art references.

In a first aspect, an embodiment of the present invention provides a method of identifying associations between claim elements in patent documents and reference objects based on association-related data, and of storing the associations in a database, comprising steps of: (a) selecting a first claim element having a first unique identifier stored in the database; (b) selecting a first reference object having a second unique identifier in the database; (c) collecting association-related data between the first reference object and the first claim element; and (d) if there is a first similarity identified in the association-related data, generating a first database link from the first unique identifier to the second unique identifier, and storing the first database link in the database.

In a second aspect, an embodiment of the present invention provides a computer-readable medium having computer-executable instructions that, when executed by a computer, cause the computer to perform the method of identifying associations between claim elements in patent documents and reference objects based on association-related data, and of storing the associations in a database, comprising steps of: (a) selecting a first claim element having a first unique identifier stored in the database; (b) selecting a first reference object having a second unique identifier in the database; (c) collecting association-related data between the first reference object and the first claim element; and (d) if there is a first similarity identified in the association-related data, generating a first database link from the first unique identifier to the second unique identifier, and storing the first database link in the database.

In a third aspect, an embodiment of the present invention provides a system for identifying and storing associations between claim elements in patent documents and reference objects based on association-related data, comprising: a processor adapted to uniquely identify claims elements and reference objects using unique identifiers, and adapted to generate database links based on the similarities between claim elements and reference objects identified in the association-related data; and a database adapted to store the database links and the uniquely identified claim elements and reference objects; wherein the processor is operatively coupled to memory for real-time processing, and wherein the database links relate between unique identifiers stored in the database.

In a fourth aspect, an embodiment of the present invention provides a database, for storing associations between claim elements in patent documents and reference objects based on user input, constructed and adapted to be operatively connected to a processor adapted to uniquely identify claims elements and reference objects using unique identifiers, and adapted to generate database links between claim elements and reference objects, and amongst claim elements and reference objects, respectively, the database comprising: uniquely identified claim elements; and uniquely identified reference objects; and database links that relate between the unique identifiers stored in the database.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system in accordance with an embodiment of the present invention;

FIG. 2 is a first flowchart in a series of two flowcharts detailing a method in accordance with an embodiment of the present invention;

FIG. 3 is a second flowchart in the series of two flowcharts detailing a method in accordance with an embodiment of the present invention;

FIG. 4 is a flowchart detailing a process for marking up claim elements in accordance with an embodiment of the present invention;

FIG. 5 is a flowchart detailing a process for marking up reference objects in accordance with an embodiment of the present invention;

FIG. 6 is a flowchart detailing a process of deriving database links between claim elements and reference objects based on similarities between claim elements in accordance with an embodiment of the present invention;

FIG. 7 is a flowchart detailing a process for deriving database links between claim elements and reference objects based on similarities between reference objects in accordance with an embodiment of the present invention;

FIG. 8 is a flowchart detailing a process for displaying database links in a user-friendly chart in accordance with an embodiment of the present invention;

FIG. 9 is an exemplary partial chart of claim elements and reference objects showing associations made between specific claim elements and specific reference objects, as detailed in the flowchart of FIG. 8, in accordance with an embodiment of the present invention;

FIG. 10 is an exemplary display of a patent information window of a graphical user interface in accordance with an embodiment of the present invention;

FIG. 11 is an exemplary display of an information window of a graphical user interface for marking up claim elements in accordance with an embodiment of the present invention; and

FIG. 12 is an exemplary display of a graphical user interface for collecting information regarding associations between claim elements and reference objects in accordance with an embodiment of the present invention.

### DETAILED DESCRIPTION OF THE PREFERRED EMBODIMENTS

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

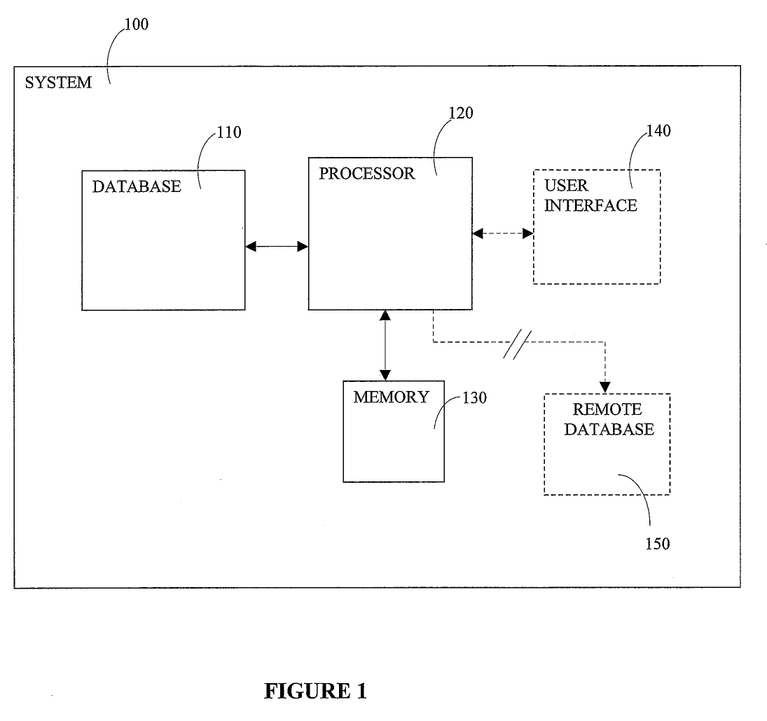

Referring to FIG. 1, a block diagram of the inventive system 100 is shown generally. The system 100 comprises a database 110, a processor 120, and a memory means 130. The processor 120 and memory means 130 are operatively coupled together. The database 110 is operatively connected to the processor 120.

As a general overview, the processor 120 and the memory 130 work in conjunction to provide real-time processing of association-related data that relates to associations between claim elements and reference objects, and amongst claim elements and reference objects, respectively. The association-related data may be either previously determined and thus retrievable from the database 110, or determined in real-time by the processor 120, and thus stored as association-related data is stored in the database 110.

According to an alternative embodiment, the processor 120 is operatively coupled to a user interface 140. The user interface 140 collects association-related data, as user input data from a user. The user input data details associations between claim elements and reference objects, or amongst claim elements and reference objects, respectively.

According to another alternative embodiment, the processor 120 is operatively connected to a remote database 150. The remote database may be either a public or a private database. A public database is one that is searchable by the public, such as the U.S. Patent and Trademark Office. A private database is not accessible to the public, but still accessible to the processor 120. For example, the system could have access to a remote database that stores association-related data on previously analyzed reference objects, such as infringing devices.

By way of further clarification, claim elements may be entire patent claims, or portions (e.g., sub-paragraphs thereof) of a patent claim. A user will identify a claim element by marking up or indicating where the claim element is located in the claim. If an entire claim is a claim element, the entire claim is marked up.

Reference objects may be entire objects, or portions thereof, that may be generally explained as including, but not limited to, descriptions, drawings, images, graphical representations, or portions thereof, disclosing prior art or infringing devices, apparatus, methods, or systems. It is clearly understood that several reference objects could be included within an object, such as a drawing or an image. These reference objects can serve not only as representations of infringement devices or of prior art in the pertinent field, but can serve as explanations of, or as clarifications to, claim elements. And, similar to identifying a claim element, a reference object is identified by marking up or indicating where the reference object is located in the object. So, for example, within a single image, there may be several reference objects that may be marked up to indicate each specific location within that single image.

The database 110 is adapted to comprise certain tombstone information on all patents of interest, together with the full text of the claims or a subset thereof. The tombstone information typically contained in the database 110 may include some or all of the patent number, the application number, the title of the patent, the claims, the drawings, the patent description pages and the abstract of the patent. Those having ordinary skill in this art will readily appreciate that there may be other fields that may also be included for each entry in the database 110. Typically, the tombstone information is downloaded from time to time in bulk from a remote database 150, such as from one or more of the Patent Office records databases through an Internet connection (not clearly shown).

The system also contemplates the entry of individual records into the database 110 as a supplement to, or in place of, the bulk download of records through the user interface 140, or directly through the processor 120.

It should be mentioned that the term database is used in its broadest sense. The association-related data may be stored in any form of relational database, such as a structured query language (SQL) compatible database, an object database, an Extensible Markup Language (XML) database, or in a Microsoft Excel™ spreadsheet file, for example. Thus, the term “database” is used to encompass many types of data storage means.

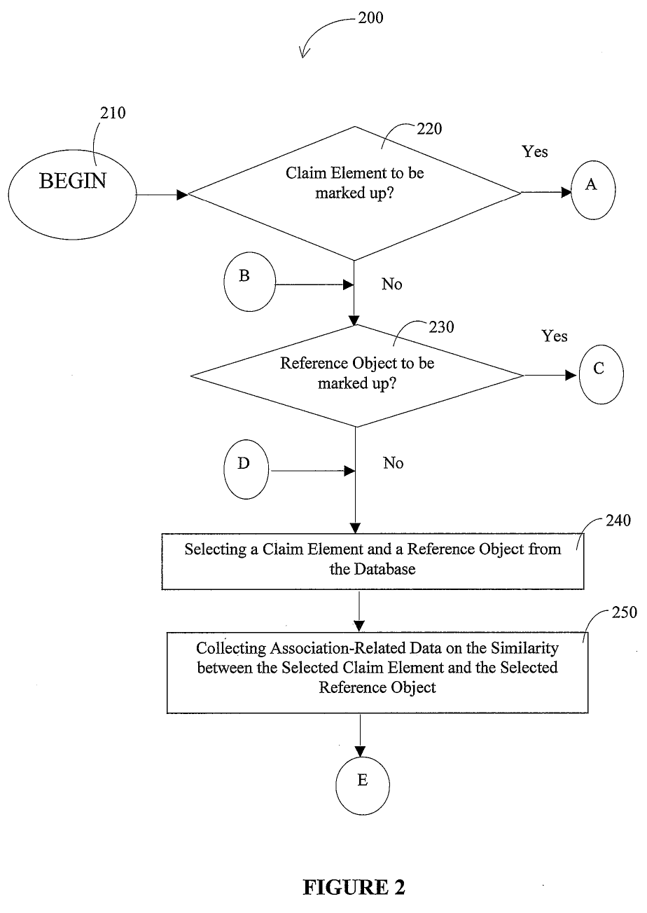

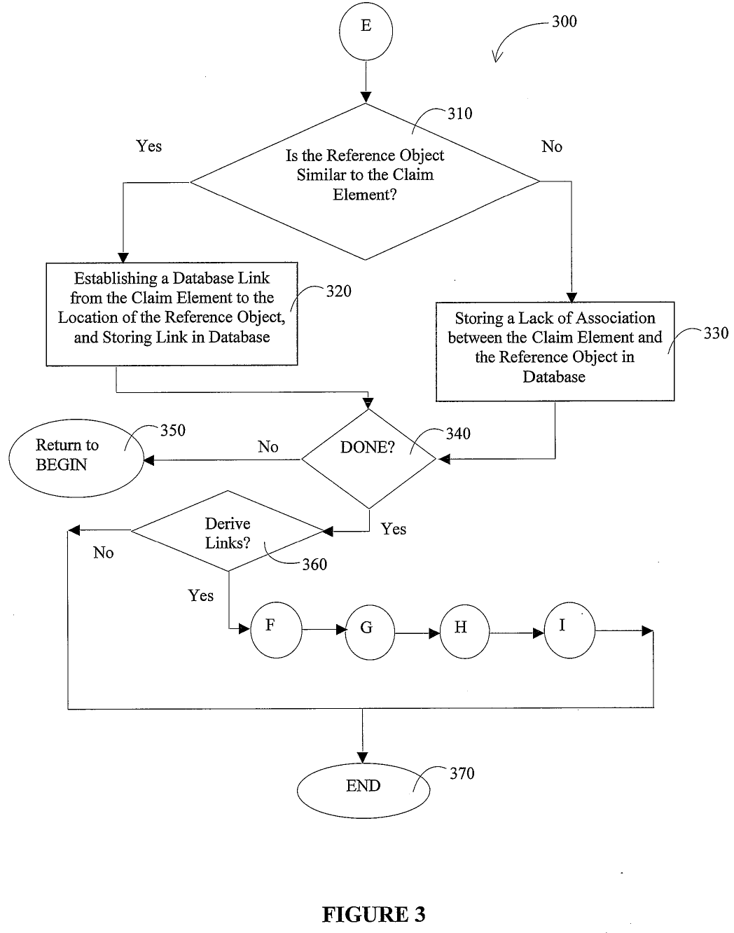

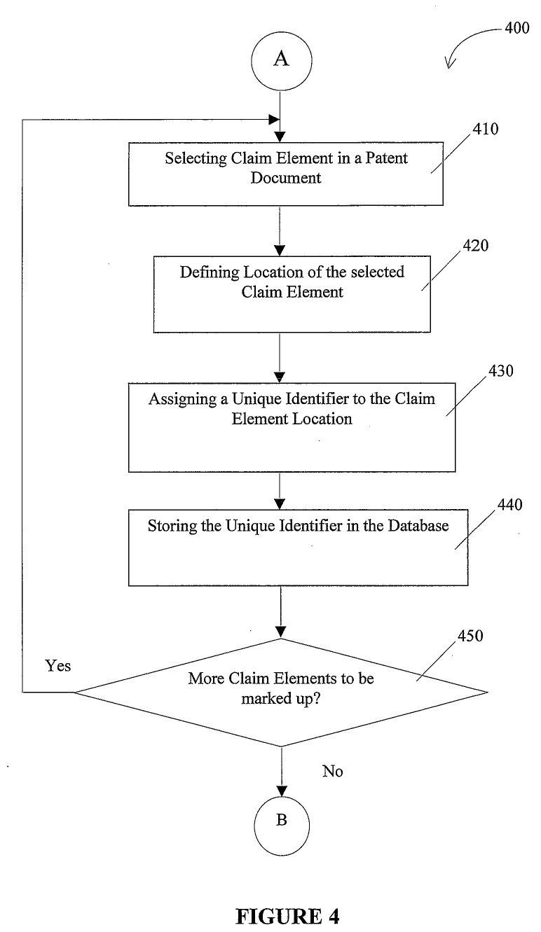

Referring now to FIGS. 2 through 8, the method of the present invention is explained through the discussion of the flowcharts shown in FIGS. 2 through 8. In FIGS. 2 and 3, the main process of the present invention is detailed in a series of two flowcharts 200 and 300. The remaining flowcharts (400, 500, 600, 700, and 800) shown in FIGS. 4 through 8, detail sub-processes or additional processes of the present invention.

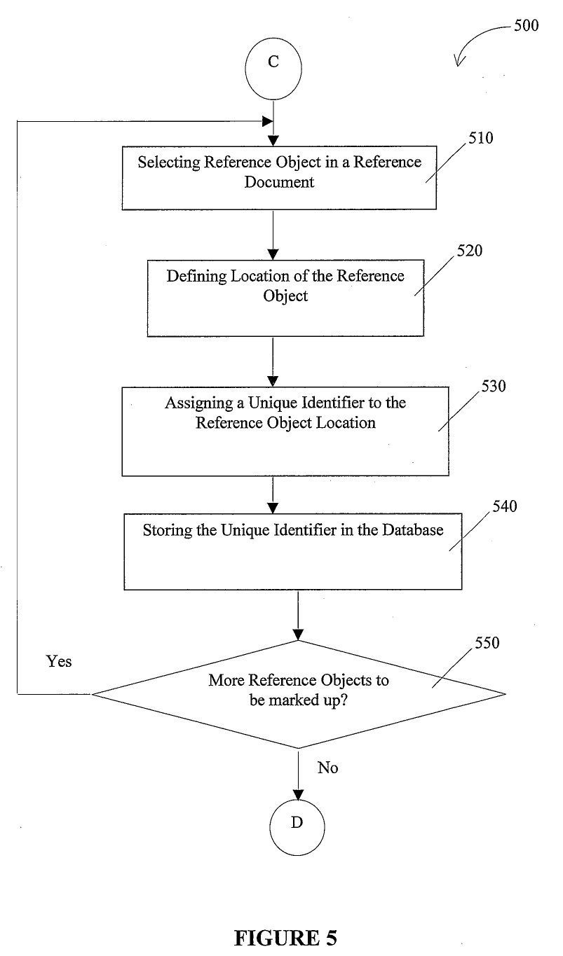

As shown in FIG. 2, the main process begins at step 210. The next step is an optional decision step 220 that queries a user as to whether or not a claim element should be marked up. If the answer is yes, the connector A is followed to initiate a claim mark-up process 410. The claim mark-up process 410 will be discussed further below with reference to FIG. 4. If the query is answered in the negative, a further optional decision step 230 is taken that queries a user as to whether or not a reference object should be marked up. If the answer is yes, connector C is followed to initiate a reference object mark-up process 500. The reference object mark-up process 500 will be discussed further below with reference to FIG. 5.

After step 230, the next step 240 involves selecting a claim element and a reference object from the database. This step 240 is initiated based on user input data. It should be readily understood that because the database may already be populated with data on claim elements and reference objects when the process is initiated at step 210, the user may not need to mark up claim elements and reference objects. Rather, the user may simply move to step 240 to effecting associations between claim elements and reference objects stored in the database 110 (shown in FIG. 1).

It should be mentioned that associations, or a lack thereof, are determined based on whether there is a similarity or dissimilarity between claim elements and reference objects. Accordingly, after making the selection in step 240, step 250 enables the system 100 to collect association-related data on the similarity or dissimilarity between the selected claim element and the selected reference object.

For further clarification, association-related data may be user input data obtained in real-time from users connected to the system through the user interface 140. Association-related data may also be previously determined data stored in the database 110. As will be readily apparent to the skilled artisan, previously determined data may include data obtained through previous interfaces with users. Also contemplated is the processor 120 having artificial intelligence (AI) capabilities (as commonly understood by the skilled artisan) to produce association-related data based on similarities found between reference objects and claim elements.

While step 250 refers to collecting association-related data on the similarity between a claim element and a reference object, step 250 may also collect association-related data on the similarities amongst claim elements and amongst reference objects, respectively. Thus, step 240 may also be modified to select two claim elements or two reference objects, respectively.

Step 250 may also include connecting to a remote database 150 to obtain association-related data. Alternatively, the association-related data may be collected from within the database 110, if an association-related data base been previously determined and stored therein.

After step 250 is completed, connector E is followed to the second flowchart 300 shown in FIG. 3. In FIG. 3, connector E is followed to decision step 310. The decision step 310 queries whether or not the selected reference object is similar to the selected claim element based on the association-related data collected.

If the association-related data indicates that there is a similarity between the selected reference object and the selected claim element, step 320 is executed. Step 320 establishes a database link from the claim element to the database location of the reference object, and then stores the database link in the database 110. If the association-related data indicates a dissimilarity between the selected reference object and the selected claim element, step 330 is executed. Step 330 stores a lack of association between the selected claim element and the reference object.

As mentioned previously with respect to steps 240, 250, 310, 320, and 330, the present invention contemplates collecting information from the user regarding similarities and dissimilarities amongst claim elements and amongst reference objects, respectively. Thus, it will be readily understood by the skilled artisan that step 240 may be modified to select claim elements only, or reference objects only. The collected information regarding similarities or dissimilarities may then be stored as a database link, or as a lack of association, through steps 320 or 330, in the database 110.

As well, step 250 may be modified to collect association-related data with respect to the degree of similarity between claim elements and reference objects, and amongst claim elements and reference objects, respectively. Thus, any association-related data may include a range of values, for example, where the values range between a high degree of similarity to a low degree of similarity between claim elements and reference objects. As such, step 250 would be modified to collect a value that represents the degree of similarity, or dissimilarity, between reference objects and claim elements, or alternatively, amongst claim elements and reference objects, respectively. Step 320 would also be modified to store the value with the database link (established in step 320) in the database, such that the value is later retrievable along with the database link.

Referring again to FIG. 3, after following steps 320 and 330, a decision step 340 is executed. The decision step 340 queries whether the process of establishing database links between claim elements and reference objects is completed. If the process is not complete (done), step 350 is taken and the process returns to step 210 to return to begin, shown in FIG. 2.

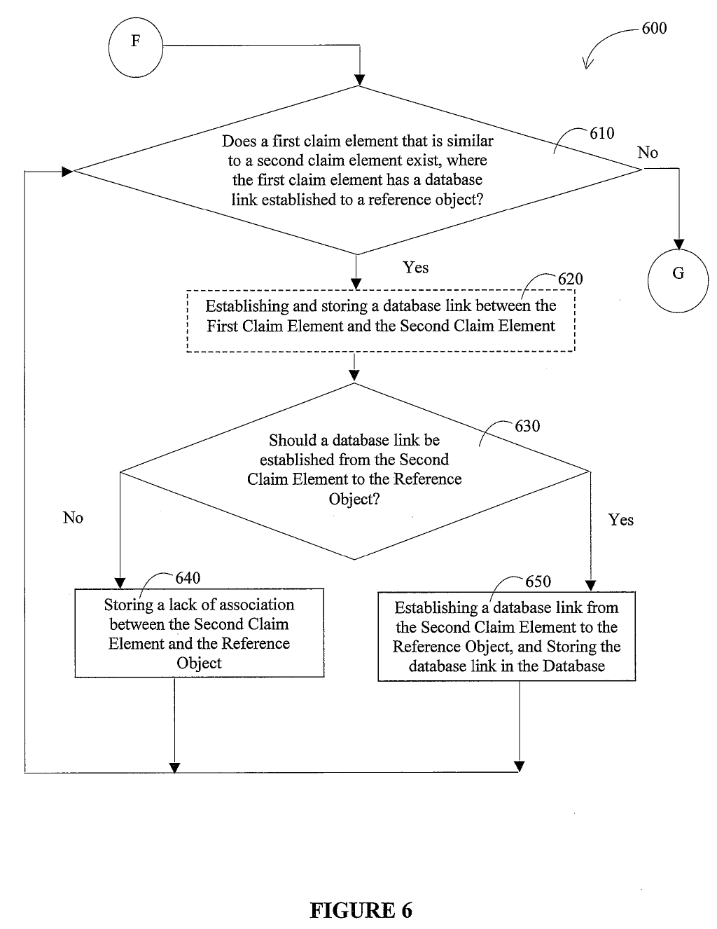

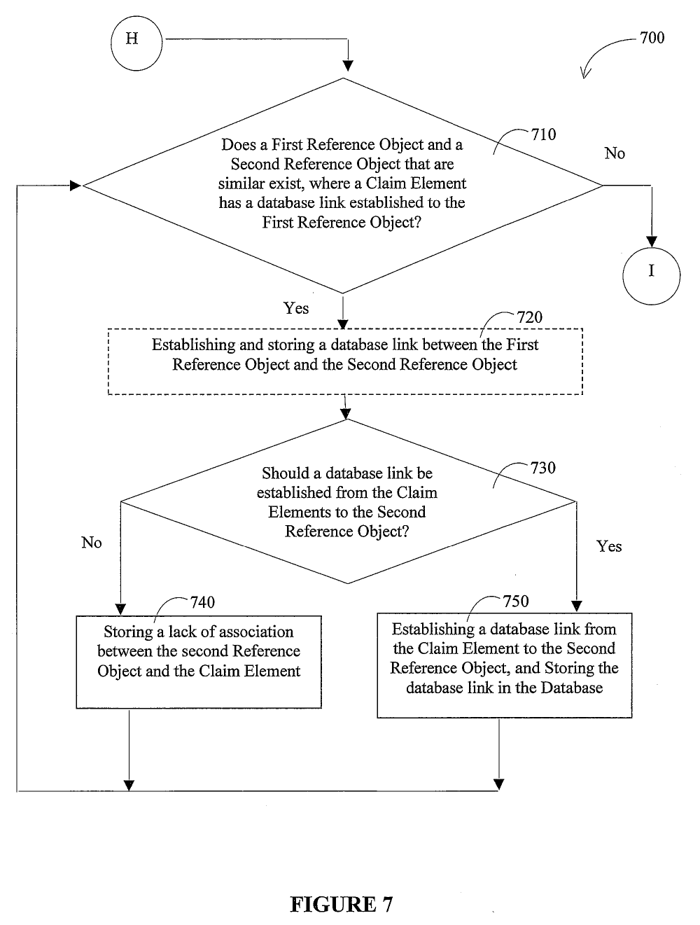

If the process is complete, the main process is followed to another decision step 360. The decision step 360 queries whether or not database links should be derived based on the database links previously established. If the query is answered in the negative, the process is followed to final step 370, and thus ends. Otherwise, a series of connectors F, G, H, and I, to be explained further below with reference to FIGS. 6 and 7, are followed to eventually return to the final step 370.

Referring now to FIG. 4, a flowchart 400 is shown that illustrates a process for marking up claim elements. Connector A, which is followed from the main process shown in FIG. 2, leads to the first step 410 in the mark-up process. Step 410 selects a claim element in a patent document based on associated-related data. Next, step 420 defines the location of the selected claim element. Step 430 is then executed to assign a unique identifier to the location of the claim element. Next, step 440 stores the assigned unique identifier in the database 110. Finally, a decision step 450 queries a user as to whether additional claim elements should be marked up. If the answer is yes, the process is followed back to step 410 to repeat steps 410 through 450. Otherwise, connector B returns the process back to the main process, depicted in flowchart 200, to perform step 230 (shown in FIG. 2).

In FIG. 5, a flowchart 500 is shown that details a similar process to flowchart 400, but for marking up reference objects, rather than claim elements. Connector C is followed from the main process shown in FIG. 2 to begin the process at step 510. Step 510 selects a reference object, which may be a portion of a reference document, etc. (as explained previously), based on associated-related data obtained. Next, based on the selection in step 510, step 520 defines the location of the selected reference object. Step 530 is then executed to assign a unique identifier to the reference object. Next, step 540 stores the assigned unique identifier in the database 110. Finally, a decision step 550 queries a user as to whether additional reference objects should be marked up. If so, the process is followed back to step 510 to repeat steps 510 through 550. Otherwise, connector D returns the process back to the main process to perform step 240 (shown in FIG. 2).

In FIG. 6, a flowchart 600 is shown that details a process of deriving database links between claim elements and reference objects based on similarities between at least two claim elements. Connector F is followed from the flowchart 300 (shown in FIG. 3) to decision step 610. The decision step 610 queries whether or not there is a first claim element that is similar to a second claim element in the database, either based on a database link that was previously established between them or based on newly obtained association-related data regarding a similarity between them, as a first criterion; and if so, whether or not the first claim element has established therewith at least one database link to a reference object, as a second criterion. Thus, the processor 120 may need to search the database to meet the two criteria, or analyze any new association-related data to determine whether the criteria are satisfied. Otherwise, no further database links may be derived, and connector G is followed back to the main process in flowchart 300.

It should also be mentioned here that the processor 120 may also be capable of determining in real-time whether the above criteria are satisfied through its optional AI capabilities, for example.

If the two criteria as queried are met, an optional step 620 may be executed where a database link is established between the first claim element and the second claim element, if the database link between the two has not been established previously. Following that, decision step 630 is executed to query whether or not a database link should be established between the second claim element and the (at least one) reference object, based on association-related data. If the query is answered in the negative, step 640 is followed. Otherwise, step 650 is executed.

Step 640 stores a lack of association between the second claim element and the reference object in the database 110 (FIG. 1). Step 650 establishes a database link from the second claim element to the reference object, and then stores the database link in the database 110 (FIG. 1). Following steps 640 and 650, the process returns to decision step 610 to either return to the main process or continue deriving links.

In FIG. 7, a flowchart 700 is shown that details a similar process to flowchart 600, but for deriving database links between claim elements and reference objects based on similarities between reference objects, rather than claim elements. Connector H is followed in flowchart 300 (shown in FIG. 3) to decision step 710. Decision step 710 queries whether or not there is a first reference object that is similar to a second reference object, either based on a database link that was previously established between them, or based on new association-related data regarding a similarity between them, as a first criterion; and if so, whether or not a claim element has established therewith a database link to the first reference object, as a second criterion. Thus, the processor 120 may need to search the database to meet the two criteria, or analyze any new association-related data to determine whether the criteria are satisfied. Otherwise, no further database links may be derived, and connector I is followed back to the main process in flowchart 300, and thence to the end at step 370.

Again, the processor 120 may also be capable of determining in real-time whether the above criteria are satisfied through its optional AI capabilities.

If the two criteria are met, an optional step 720 may be executed where a database link is established between the first reference object and the second reference object, if the database link between the two has not been established previously. Following that, decision step 730 is executed. The decision step 730 queries whether or not a database link should be established between the second reference object and the claim element, based on association-related data. If the query is answered in the negative, step 740 is followed. Otherwise, step 750 is executed.

Step 740 stores a lack of association between the second reference object and the claim element in the database 110 (FIG. 1). Step 750 establishes a database link from the second reference object to the claim element, and then stores the database link in the database 110. Following steps 740 and 750, the process returns to the decision step 710 to either return to the main process or continue deriving links.

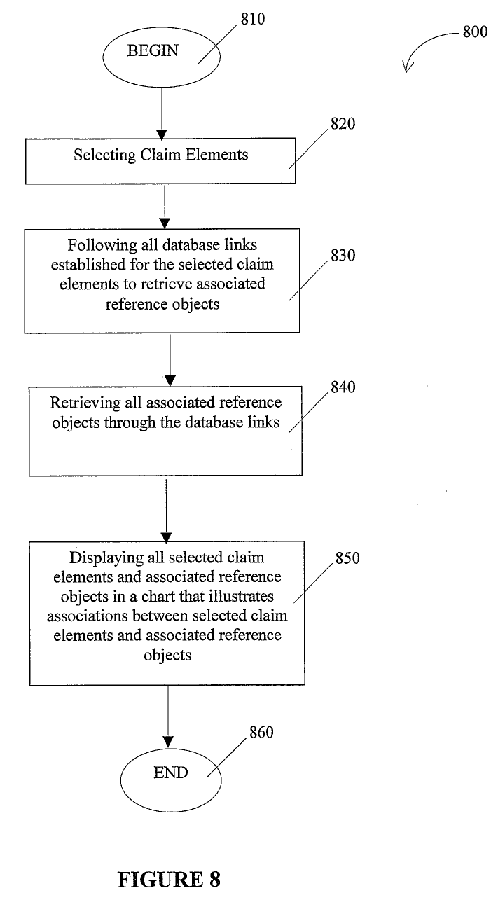

In FIG. 8, a flowchart 800 is shown that details a process for displaying database links in a user-friendly chart. The display process may be executed at any time, during or after execution of the main process detailed in flowcharts 200 and 300. The display process begins at step 810. Next, step 820 is executed to select claim elements to be displayed based on association-related data as to which claim elements should be selected. For example, the association-related data may indicate that entire patent documents and their respective claim elements should be selected. Alternatively, the association-related data may indicate that certain reference objects that, for example, form part of the accused infringing device should be selected. Accordingly, the relevant claim elements and/or reference objects will be selected. Based on the selection, step 830 is executed to follow all database links established for the selected claim elements to retrieve the associated reference objects. As will be readily understood by the skilled artisan, step 830 may contemplate following database links in the reverse if reference objects, rather than claim elements, are selected in step 820. Next, step 840 is executed to retrieve all associated reference objects links in the database to the selected claim elements. Following that, step 850 is executed to display all selected claim elements and associated reference objects in a chart that illustrates associations between selected claim elements and associated reference objects. Finally, the process ends at step 860.

While not shown, the present invention clearly contemplates that the main process shown in flowcharts 200, 300, as well as the additional display process detailed in flowchart 800, may be iterative. For example, flowcharts 400 (in FIG. 4) and 500 (in FIG. 5) illustrate an iterative implementation of those processes through decision steps 450 and 550, respectively.

It should also be mentioned that the method of the present invention contemplates an electronic mark-up of the asserted claim set(s). As discussed with reference to process steps detailed in flowcharts 400 and 500, the electronic mark-up associates a unique computer-generated identifier to each identified claim element and permits the reproduction of the text of the identified claim element together with the associated identifier. The associated computer-generated identifier may also be linked to another identifier corresponding to an identical claim element elsewhere in the claims of a patent or in another patent. Such links may be used to ensure that any associations with underlying references will be propagated to all of the claim elements linked through their associated identifiers.

The association between a claim element and its computer-generated identifier permits considerable simplification of the patent claim analysis process and the development of tools to electronically annotate the underlying references.

Further, the electronic annotation of the underlying references permits computer-based determination of novelty, obviousness and infringement issues, while obviating the traditional tabular claim chart approach.

The association between a claim element and its computer-generated identifier further considerably simplifies and automates the method disclosed, including the compilation of a claim chart and propagation and display of the mark-ups on copies of the underlying reference objects while obviating the possibility of inconsistent analysis and minimizing the possibility of error.

As a result, the present invention facilitates the construction of patent claim elements and a detailed understanding of whether the claim element reads on an accused infringing device and/or prior art reference and provides a sophisticated tool set for communicating the results of the patent claim analysis in a comprehensible, convenient and attractive format.

Furthermore, the availability of electronic mark-up of the claim language of the asserted patents permits easy and convenient compilation of libraries of claim elements that may be easily combined in various permutations to correspond to various claims. The creation of libraries facilitates the development of a patent database that may be appropriated at later points in the patent litigation process or in subsequent litigation and permits strategic approaches to litigation and indeed patent drafting.

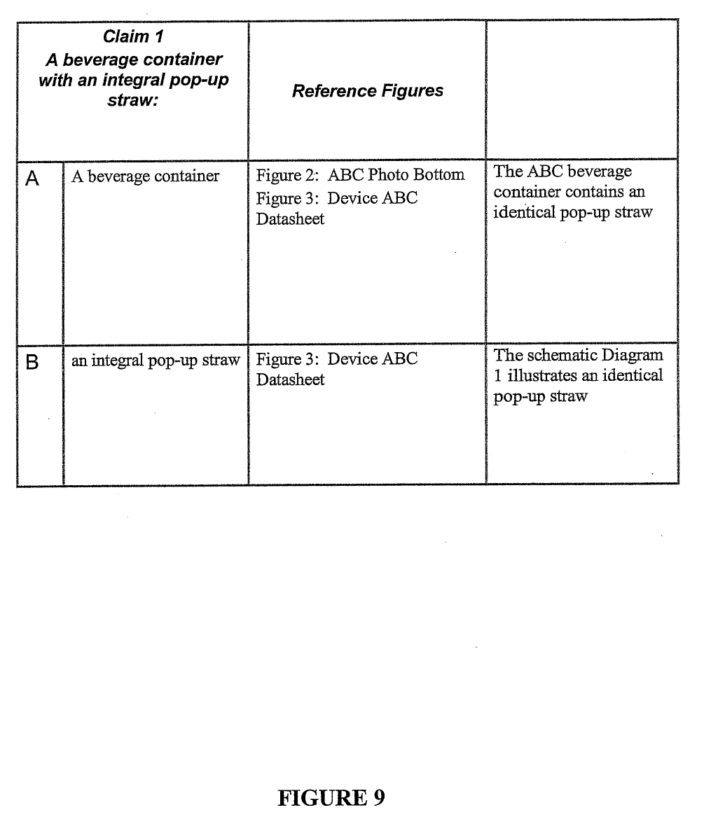

FIG. 9 is an exemplary chart of claim elements and reference objects that indicates associations (i.e., database links) established between specific claim elements and specific reference objects, as generated in the flowchart of FIG. 8, according to the present invention.

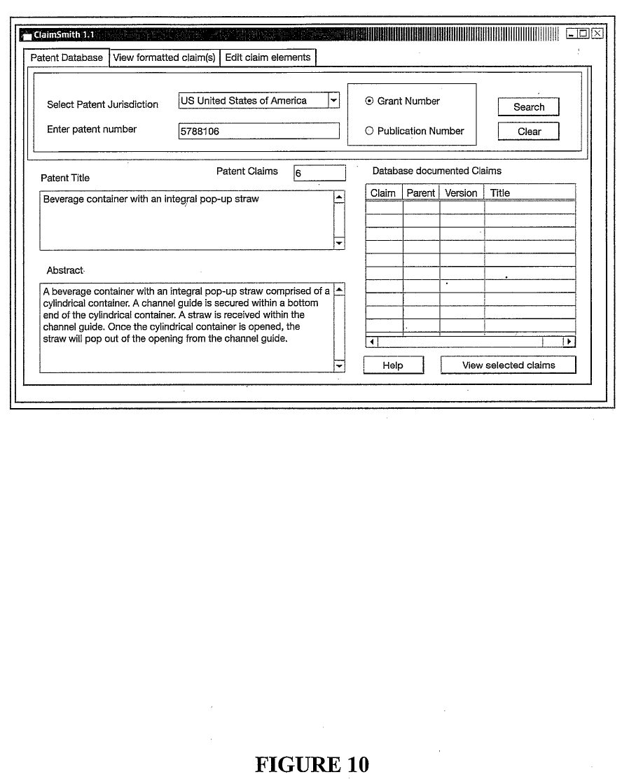

FIGS. 10, 11, and 12 show examples of a graphical user interface that may interface with the user to collect required information. As will be readily understood by the skilled artisan, various interfaces will be suitable and need not be graphical in nature.

FIG. 10 is an exemplary display of a patent information window of a graphical user interface according to the present invention.

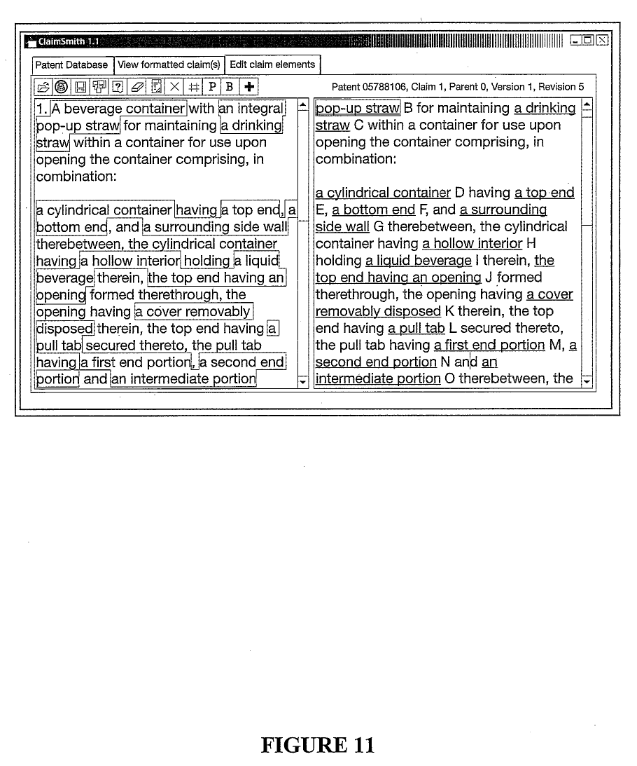

FIG. 11 is an exemplary display of an information window of a graphical user interface for marking up claim elements according to the present invention.

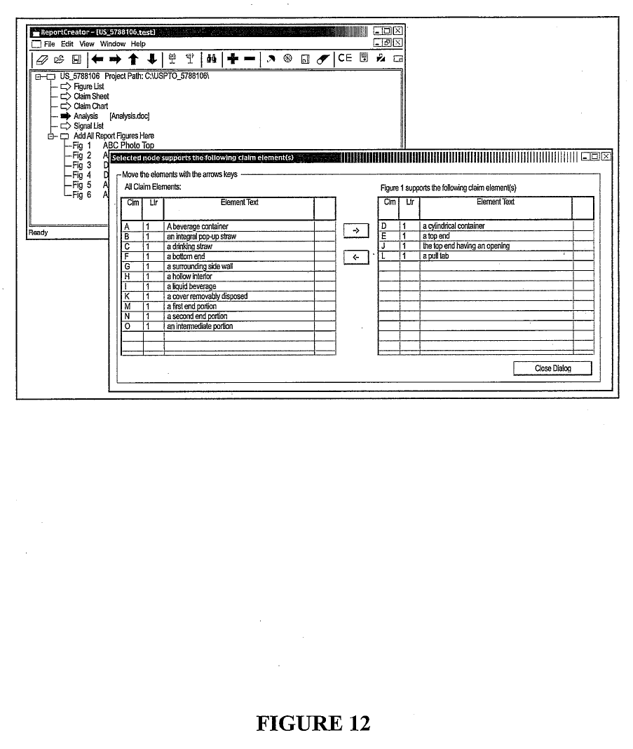

FIG. 12 is an exemplary display of a graphical user interface for collecting information regarding associations between claim elements and reference objects in accordance with the present invention.

The present invention can be implemented in digital electronic circuitry, or in computer hardware, firmware, software, or any combination thereof. Apparatus of the invention can be implemented in a computer program product tangibly embodied in a machine-readable storage device for execution by a programmable processor; and any steps or methods can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific integrated circuits), FPGAs (field-programmable gate arrays) or DSPs (digital signal processors).

Examples of such types of computers are well known in the art, and are suitable for implementing or performing the system, medium, or methods of the present invention. The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

What is claimed is:

1. A method of identifying associations between claim elements in patent documents and reference objects based on association-related data, and of storing the associations in a database, comprising steps of:
(a) selecting a first claim element having a first unique identifier stored in the database;
(b) selecting a first reference object having a second unique identifier in the database;
(c) collecting association-related data between the first reference object and the first claim element; and
(d) if there is a first similarity identified in the association-related data, generating a first database link from the first unique identifier to the second unique identifier, and storing the first database link in the database.

2. A method as in claim 1, whereby collecting association-related data in step (c) involves obtaining association-related data from users as user input data.

3. A method as in claim 1, whereby collecting association-related data in step (c) involves retrieving the association-related data from the database.

4. A method as in claim 1, further including step (e) if there is a dissimilarity identified in the association-related data, storing a lack of association between the first unique identifier and the second unique identifier in the database.

5. A method as in claim 1, repeating the steps (a) through (d) for a plurality of claim elements.

6. A method as in claim 1, repeating the steps (a) through (d) for a plurality of reference objects.

7. A method as in claim 5, repeating the steps (a) through (d) for a plurality of reference objects.

8. A method as in claim 1, repeating the steps (a) through (d) for a plurality of patent documents.

9. A method as in claim 1, wherein the step of selecting the first claim element includes steps of:
(a.i) assigning the first unique identifier to the first claim element,
(a.ii) storing the first unique identifier in a first database location.

10. A method as in claim 1, wherein the steps of selecting the first reference object include steps of:
(b.i) assigning the second unique identifier to the first reference object, and
(b.ii) storing the second unique identifier corresponding in a second database location.

11. A method as in claim 1, repeating the steps (a) through (d) for a plurality of claim elements and for a plurality of reference objects, and further including steps of:
(f) deriving a second similarity between a second claim element and the first reference object based on a third similarity identified in the association-related data between the first claim element and the second claim element, and
(g) storing the second similarity as a database link, from the second claim element to the first reference object, in the database.

12. A method as in claim 1, repeating the steps (a) through (d) for a plurality of claim elements and for a plurality of reference objects, and further including steps of:
(h) deriving a fourth similarity between the first claim element and a second reference object based on a fifth similarity identified in the association-related data between the first reference object and the second reference object; and
(i) storing the fourth similarity as a database link, from the first claim element to the second reference object, in the database.

13. A method as in claim 1, repeating steps (a) through (d) for a plurality of claim elements and for a plurality of reference objects, and further including an additional step of generating a chart showing a plurality of similarities, based on the database links established, between the plurality of claim elements and the plurality of reference objects, and amongst the plurality of claim elements and the plurality of reference objects, respectively.

14. A method as in claim 11, repeating steps (a) through (d) for a plurality of claim elements and for a plurality of reference objects, and further including a step of generating a chart showing similarities and derived similarities, based on the database links established, between the plurality of claim elements and the plurality of reference objects, amongst the plurality of claim elements and the plurality of reference objects, respectively.

15. A method as in claim 12, repeating steps (a) through (d) for a plurality of claim elements and for a plurality of reference objects, and further including a step of generating a chart showing similarities and derived similarities, based on the database links established, between the plurality of claim elements and the plurality of reference objects, amongst the plurality of claim elements and the plurality of reference objects, respectively.

16. A method as in claim 1, wherein step (c) further includes a step of collecting association-related data on a degree of similarity between the first reference object and the first claim element, and wherein step (d) further includes a step of storing the degree of similarity in the database in association with the first database link.

17. A method as in claim 1, wherein the first reference object is in an electronic data format and is selected from a group consisting of: a patent reference, a patent application, a published patent application, an international application, an industrial design, a design patent, an Internet uniform resource locator, a drawing, a graph, a photograph, an image, a design, and a chart.

18. A method as in claim 1, wherein a first reference object is replaced by a second claim element in steps (b), (c), and (d), and wherein steps (b), (c), and (d) are then repeated.

19. A method as in claim 1, wherein a first claim element is replaced by a second reference object (a), (c), and (d), and wherein steps (a), (c), and (d) are repeated.

20. A method as in claim 1, wherein the first similarity may be further identified by a range of values that represent a high degree of similarity to a low degree of similarity between the first claim element and the first reference object, and wherein step (c) includes collecting a specific value, within the range of values, as part of collecting the association-related data on the first similarity between the first reference object and the first claim element, and step (d) involves storing the value with the database link in the database, such that the value is retrievable along with the database link.

21. A computer-readable medium having computer-executable instructions that, when executed by a computer, cause the computer to perform the method of claim 1.

22. A system for identifying and storing associations between claim elements in patent documents and reference objects based on association-related data, comprising:
a processor adapted to uniquely identify claims elements and reference objects using unique identifiers, and adapted to generate database links based on the similarities between claim elements and reference objects identified in the association-related data; and
a database adapted to store the database links and the uniquely identified claim elements and reference objects;
wherein the processor is operatively coupled to memory for real-time processing, and
wherein the database links relate between unique identifiers stored in the database.

23. A system as in claim 22, wherein the system further comprises a user interface operatively coupled to the processor and adapted to collect user input on similarities between claim elements and reference objects, and amongst claim elements and reference objects, respectively.

24. A system as in claim 22, wherein the system further comprises a remote database, operatively connected to the processor, having searchable reference objects, and wherein the processor is capable of collecting association-related data from the remote database.

25. A system as in claim 23, wherein the system further comprises a remote database, operatively connected to the processor, having searchable reference objects, and wherein the processor is capable of collecting association-related data from the remote database.

26. A database, for storing associations between claim elements in patent documents and reference objects based on user input, constructed and adapted to be operatively connected to a processor adapted to uniquely identify claim elements and reference objects using unique identifiers, and adapted to generate database links between claim elements and reference objects, and amongst claim elements and reference objects, respectively, the database comprising:
uniquely identified claim elements; and
uniquely identified reference objects; and
database links that relate between the unique identifiers stored in the database.

27. A database as in claim 1, wherein the database is adapted to generate database links based on similarities between claim objects and reference objects, and respectively amongst claim elements and reference objects.
